(19) United States
(12) Patent Application Publication
(10) Pub. No.: US 2021/0224109 A1
(43) Pub. Date: Jul. 22, 2021

(54) SYSTEMS AND METHODS FOR ORCHESTRATING CLOUD RESOURCES

(71) Applicant: Cisco Technology, Inc., San Jose, CA (US)

(72) Inventor: Chunhui Wong, Santa Clara, CA (US)

(21) Appl. No.: 16/744,910

(22) Filed: Jan. 16, 2020

(51) Int. Cl. G06F 9/48; G06F 9/50; G06F 11/34; G06N 20/00

(52) U.S. Cl. CPC G06F 9/4881; G06N 20/00; G06F 11/3495; G06F 9/5072

(57) ABSTRACT

In one embodiment, a method includes generating, by a controller, intent-based entries. The intent-based entries include information associated with scheduling of service instances. The method also includes receiving, by the controller, feedback from an assurance platform. The feedback is generated by the assurance platform using metrics received from cloud service providers. Each of the cloud service providers is associated with an agent. The method further includes determining, by the controller, updates for the intent-based entries based on the feedback and communicating, by the controller, the updates for the intent-based entries to agents of the cloud service providers.

### TECHNICAL FIELD

This disclosure generally relates to orchestrating resources, and more specifically to systems and methods for orchestrating cloud resources.

### BACKGROUND

Traditional methods for managing resources for cloud services involve significant complexity. For example, certain existing methods rely on an imperative, siloed, and complex hybrid orchestrator that requires cloud-operation and site reliability engineering teams to write scripts, tailor requirements as code, and monitor/assure service quality at all times.

### BRIEF DESCRIPTION OF THE DRAWINGS

FIG. 1 illustrates a system for orchestrating cloud resources, according to certain embodiments;

FIG. 2 illustrates a table that may be used by the system of FIG. 1, according to certain embodiments;

FIG. 3 illustrates a method for orchestrating cloud resources, according to certain embodiments; and

FIG. 4 illustrates a computer system that may be used by the systems and methods described herein, according to certain embodiments.

### DESCRIPTION OF EXAMPLE EMBODIMENTS

### Overview

According to an embodiment, a controller includes one or more processors and one or more computer-readable non-transitory storage media coupled to the one or more processors. The one or more computer-readable non-transitory storage media include instructions that, when executed by the one or more processors, cause the controller to perform operations including generating intent-based entries. The intent-based entries include information associated with scheduling of service instances. The operations also include receiving feedback from an assurance platform. The feedback is generated by the assurance platform using metrics received from cloud service providers. Each of the cloud service providers is associated with an agent. The operations further include determining updates for the intent-based entries based on the feedback and communicating the updates for the intent-based entries to agents of the cloud service providers.

In certain embodiments, the agents of the cloud service providers schedule the service instances using the updates for the intent-based entries and local information of the cloud service providers. The local information of the cloud service providers may be associated with storage and compute resources of the cloud service providers. The metrics may include at least one of: key performance indicators (KPIs) associated with the cloud service providers and/or cost metrics associated with the cloud service providers. In some embodiments, the feedback includes one or more predictions generated by the assurance platform using machine learning algorithms. The intent-based entries are associated with at least one of: a service, a region, a Quality of Service (QoS) class, and/or a state. In certain embodiments, the cloud service providers are located within a single region.

According to another embodiment, a method includes generating, by a controller, intent-based entries. The intent-based entries include information associated with scheduling of service instances. The method also includes receiving, by the controller, feedback from an assurance platform. The feedback is generated by the assurance platform using metrics received from cloud service providers. Each of the cloud service providers is associated with an agent. The method further includes determining, by the controller, updates for the intent-based entries based on the feedback and communicating, by the controller, the updates for the intent-based entries to agents of the cloud service providers.

According to yet another embodiment, one or more computer-readable non-transitory storage media embody instructions that, when executed by a processor, cause the processor to perform operations including generating intent-based entries. The intent-based entries include information associated with scheduling of service instances. The operations also include receiving feedback from an assurance platform. The feedback is generated by the assurance platform using metrics received from cloud service providers. Each of the cloud service providers is associated with an agent. The operations further include determining updates for the intent-based entries based on the feedback and communicating the updates for the intent-based entries to agents of the cloud service providers.

Certain embodiments of this disclosure may include one or more of the following technical advantages over previous systems: (1) performing dynamic scheduling allocation for optimal quality of experience (QoE) services as opposed to static scheduling allocation, which may result in over-provisioned resources; (2) providing proactive agents (e.g., brokers) for cloud service providers that schedule resources to optimize quality and/or costs; (3) providing for collaboration among agents of cloud service providers to share intent-based information using pseudonyms and/or federation as opposed to an imperative orchestrator with often siloed and error-prone configurations; (4) providing simplified, intent-based information consumed by a federated, distributed agent of a cloud service provider to relieve complexity and responsibility of the orchestrator; (5) providing better quality and overall capital expenditure ratio and cloud context-aware bidding with crowdsource and peer recommendations as opposed to human, labor-intensive searching; (6) generating intent-based information for services that considers resource requirements, KPI/service-level agreements (SLAs), life-cycles, regions, scaling (e.g., in/out, up/down) conditions, affinity rules, and/or anti-affinity rules under failure or maintenance conditions; and (7) performing dynamic scheduling allocation using machine learning algorithms and crowdsourcing to automatically optimize services to satisfy SLAs and lower total cost of ownership (TCO) in hybrid and multi-cloud environments.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

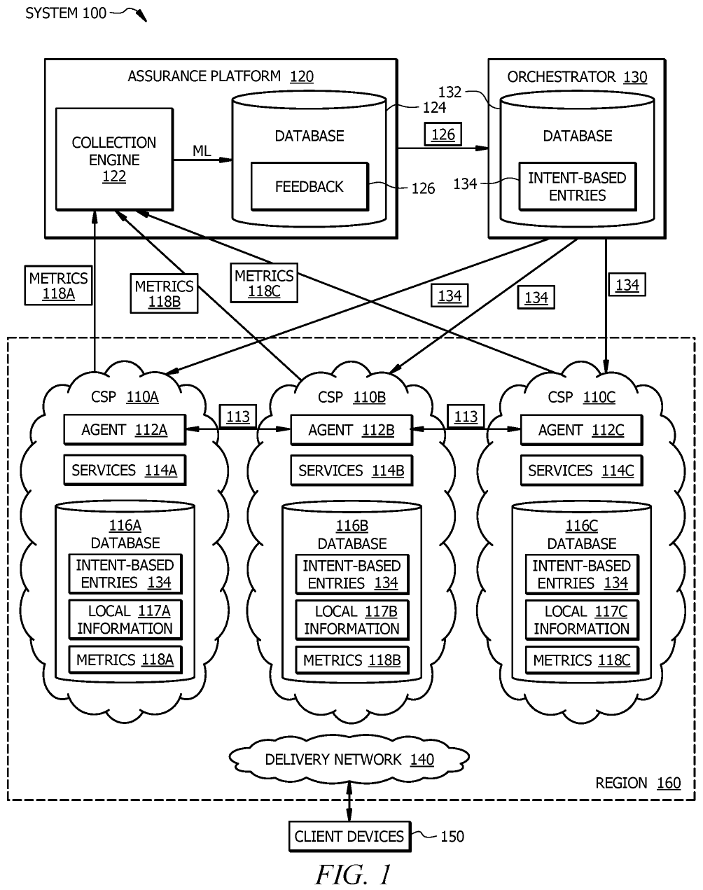

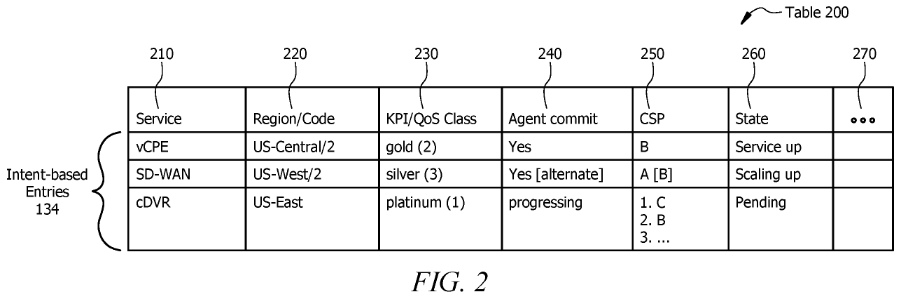

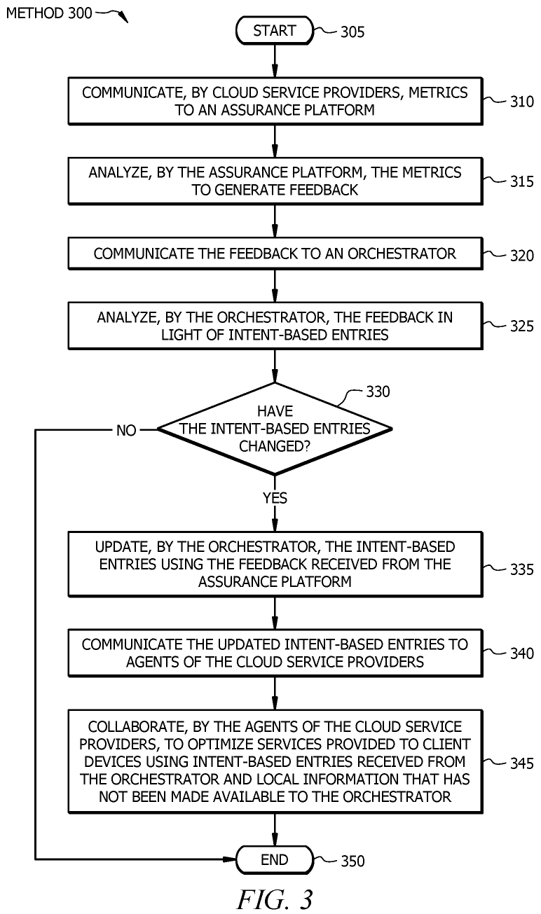

This case generally involves systems and methods for orchestrating multi-cloud resources. In certain embodiments, the systems and methods include a federated, intent-driven resource scheduler and orchestrator. With the advent of service-mesh, there is increasing demand for dynamic service resource scheduling and placement under a dynamic cost structure due to increasing competition among cloud service providers and demand for high quality of service with capital expenditures (CAPEX)/operating expenses (OPEX) optimization in hybrid and multi-cloud environments. To address these demands, this disclosure proposes autonomous service resource placement and scheduling systems for optimal service quality and cost in hybrid and multi-cloud environments. FIG. 1 shows an example system for orchestrating cloud resources, and FIG. 2 shows an example table that may be used by the system of FIG. 1. FIG. 3 shows an example method for orchestrating cloud resources. FIG. 3 shows an example computer system that may be used by the systems and methods described herein.

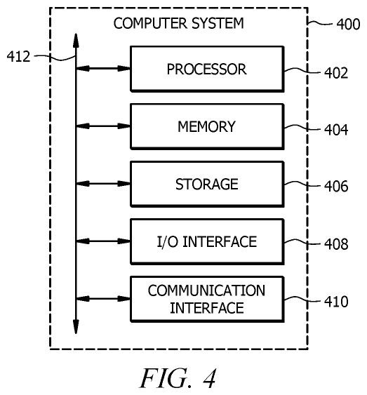

FIG. 1 illustrates an example system 100 for orchestrating cloud resources. System 100 or portions thereof may be associated with an entity, which may include any entity, such as a business or company (e.g., a service provider) that orchestrates cloud resources. The components of system 100 may include any suitable combination of hardware, firmware, and software. For example, the components of system 100 may use one or more elements of the computer system of FIG. 4. System 100 includes a cloud service provider 110A, a cloud service provider 110B, and a cloud service provider 110C (collectively, cloud service providers 110), an assurance platform 120, an orchestrator 130, a delivery network 140, client devices 150, and a region 160.

System 100 may include one or more networks that facilitate communication between components of system 100. For example, one or more networks of system 100 may connect one or more cloud service providers 110, assurance platform 120, orchestrator 130, and/or client devices 150. This disclosure contemplates any suitable networks. One or more portions of a network of system 100 may include an ad-hoc network, an intranet, an extranet, a virtual private network (VPN), a local area network (LAN), a wireless local area network (WLAN), a wide area network (WAN), a wireless WAN (WWAN), a metropolitan area network (MAN), a portion of the Internet, a portion of the Public Switched Telephone Network (PSTN), a Long-Term Evolution (LTE) network, a cellular telephone network, a combination of two or more of these, or other suitable types of networks. One or more portions of a network of system 100 may be a communications network, such as a private network, a public network, a connection through the Internet, a mobile network, a WI-FI network, a cloud network, etc. System 100 may include a core network (e.g., a 4G and/or 5G network), an access network, an edge network, an internet service provider (ISP) network, a network service provider (NSP) network, a cloud service provider network, an aggregation network, and the like. System 100 may implement Software-defined Wide Area Network (SD-WAN) technology. SD-WAN is a specific application of software defined networking technology applied to WAN connections (e.g., broadband Internet, 4G, 5G, LTE, Multiprotocol Label Switching (MPLS), etc.).

Cloud service providers 110 of network 100 are entities (e.g., companies) that offer network services, infrastructure, applications, and/or storage services in the cloud. In certain embodiments, cloud service providers 110 are third-party providers that own and/or manage hardware-based networking, storage, and compute resources for an enterprise. Cloud service providers 110 may include Microsoft Azure, Google Cloud Platform, Amazon Web Service, Adobe, IBM Cloud, VMware, and the like. Each cloud service provider 110 may be associated with one or more virtual machines. Cloud service providers 110 may allocate one or more virtual machines to provide one or more services. For example, cloud service provider 110A may schedule a particular virtual machine to provide a specific service at a predetermined time. Cloud service providers 110 of system 100 include an agent 112A, an agent 112B, and an agent 112C (collectively, agents 112), services 114A, services 114B, and services 114C (collectively, services 114), and a database 116A, a database 116B, and a database 116C (collectively, databases 116). In the illustrated embodiment of FIG. 1, cloud service provider 110A is associated with agent 112A, services 114A, and database 116A; cloud service provider 110B is associated with agent 112B, services 114B, and database 116B; and cloud service provider 110C is associated with agent 112C, services 114C, and database 116C.

Each agent 112 of each respective cloud service provider 110 is an administrator of its cloud service provider 110. Agents 112 may provision services 110 to client devices 150 when services 114 need to be deployed. Services 114 may be deployed in a cognitive way depending on the intent to be achieved. In some embodiments, information from one agent 112 (e.g., agent 112A) is shared with other agents 112 (e.g., agent 112B and agent 112C) to reduce the overhead demands placed on orchestrator 130. By sharing information about services 114 that cloud service providers 110 intend to provide or resources that cloud service providers 110 intend to use at a certain time, agents 112 can optimize the allocation/scheduling of resources.

In certain embodiments, agents 112 are self-optimizing. For example, agents 112 of cloud service providers 110 may choose not to share certain information with orchestrator 130, which may reduce micro-managing by orchestrator 130. In certain embodiments, agents 112 accept recommendations 113 from other agents 112. For example, if cloud service provider 110A has a better service quality than cloud service providers 110B and 110C, cloud service provider 110A may provide cloud service providers 110B and 110C with information about resource configurations used to obtain better service quality. Federated deployments allow agents 112 associated with cloud service providers 110 to transfer information about offerings among themselves. Each agent 112 understands more about its own requirements and can work on its own optimization (e.g., service quality and cost), which may offload complex work from orchestrator 130.

In some embodiments, agents 112 of cloud service providers 110 have one or more of the following responsibilities: performing crowdsource and teamwork among cloud service providers 110 in same region 160 to satisfy intent and SLA; checking downtime for their respective cloud service providers 110; checking status updates in each region 160 using one or more tools (e.g., Jira, short message service (SMS), Opsgenie, etc.); continuing progress until success using incremental retry under a failure scenario; self-planning; self-organizing; self-healing; periodically updating latest cost structures and resource pricing by leveraging one or more tools (e.g., a cloud service provider calculator); performing a gossip protocol for load-balancing; and/or updating/sharing information and status with other agents 112.

Services 114 of cloud service providers 110 are applications, services, and/or resources made available to client devices 150 from components (e.g., routers, gateways, servers, virtual machines, etc.) of cloud service provider 110. Services 114 may include network services, storage services, infrastructure as a service (IaaS), software as a service (SaaS), platform as a service (PaaS), etc. In certain embodiments, services 114 include virtual Customer Premises Equipment (vCPE) services, SD-WAN services, cloud Digital Video Recorder (cDVR) services, and the like. Services 114 may be hosted in a data center of cloud service provider 110. Services 114 may be made available to client devices 150 via delivery network 114. In certain embodiments, services 114 are provided to client devices 150 on demand and/or via the Internet.

Databases 116 of cloud service providers 110 store information for cloud service providers 110. Each database 116 is an organized collection of data that maintains information for its respective cloud service provider 110. Each database 116 may be any one or a combination of volatile or non-volatile local or remote devices suitable for storing information. Databases 116 may include random access memory (RAM), read-only memory (ROM), magnetic storage devices, optical storage devices, or any other suitable information storage device or a combination of these devices. Databases 116 may be located at any location suitable for databases 116 to communicate with assurance platform 120. Databases 116 may store intent-based entries 134 received from orchestrator 130, local information 117A, local information 117B, and local information 117C (collectively, local information 117), metrics 118A, metrics 118B, and metrics 118C (collectively, metrics 118), and the like. In the illustrated embodiment of FIG. 1, database 116A of service provider 110A stores intent-based entries 134, local information 117A, and metrics 118A, database 116B of service provider 110B stores intent-based entries 134, local information 117B, and metrics 118B, and database 116C of service provider 110C stores intent-based entries 134, local information 117C, and metrics 118C.

Intent-based entries 134 indicate service instances that need to be scheduled. For example, intent-based entries 134 may indicate that an SD-WAN service instance in a certain region needs to be scheduled by cloud service providers 110. Intent-based entries 134 are generated by orchestrator 130 and communicated to one or more cloud service providers 110. Cloud service providers 110 use intent-based entries 134 to schedule services and/or optimize services provided to client devices 150. In certain embodiments, cloud service providers 110 may use intent-based entries 134 to select a network component (e.g., a virtual machine) on which the service instance is to be scheduled. Intent-based entries 134 are discussed in more detail in FIG. 2 below.

Local information 117 is information associated with a particular cloud service provider 110 that is not made available to assurance platform 120 and/or orchestrator 130. Local information 117 may include available storage resources, compute resources and/or resource configurations of cloud service providers 110. Agents 112 of cloud service providers 110 may share local information 117 among themselves to schedule and/or optimize services, which reduces the overhead of assurance platform 120 and/or orchestrator 130. In certain embodiments, agents 112 of cloud service providers 110 use federation to share local information 117. Local information 117 may be associated with system availability (e.g., the percentage of time that a system is available), reliability (e.g., the mean time between failure and/or the mean time to repair), a response time, security (e.g., average security threats), throughput (i.e., bandwidth), capacity (e.g., the size of the workload compared to available infrastructure), scalability (e.g., the degree to which a system can support a defined growth scenario), latency, and the like. Cloud service providers 110 may use a combination of intent-based entries 134 received from orchestrator 130 and local information 117 to select a network component (e.g., a virtual machine) on which the service instance is to be scheduled.

Metrics 118 are quantifiable measures used to evaluate services 114 of cloud service providers 110. In certain embodiments, metrics 118 are generated by cloud services providers 110. Metrics 118 may be used to measure a particular characteristic of the performance or efficiency of cloud service provider 110. Metrics 118 may include key performance indicators (KPIs). A KPI is a type of performance measurement used to demonstrate how effectively cloud service provider 110 is achieving its business objectives. KPIs may be associated with availability versus recovery SLA (e.g., an indicator of availability performance compared to current service levels), workload predictable costs (e.g., an indicator of CAPEX cost for on-premise ownership versus cloud), workload variable costs (e.g., an indicator of OPEX cost for on-premise ownership versus cloud or an indicator of burst cost), CAPEX versus OPEX costs (e.g., an indicator of on-premise physical asset TCO versus cloud TCO), workload versus utilization percentage (e.g., an indicator of cost-effective cloud workload utilization), workload type allocations (e.g., workload size or an indicator of percentage of IT asset workloads using cloud), instance to asset ratio (e.g., an indicator of percentage and cost of rationalization/consolidation of IT assets or a degree of complexity reduction), and the like. Metrics 118 may include cost metrics. Cost metrics measure costs associated with one or more services 114. Cost metrics may be associated with information provided in detailed billing reports, cost and usage reports, Reserved Instances (RI) coverage reports, and the like. In certain embodiments, cloud service providers 110 communicate (e.g., report) metrics 118 to assurance platform 120.

Assurance platform 120 of system 100 monitors the performance of cloud service providers 110. Assurance platform 120 collects data (e.g., metrics 118) from cloud service providers 110 and reports data to orchestrator 130. In certain embodiments, assurance platform 120 is an assurance server. Assurance platform 120 analyzes metrics 118 received by cloud service providers 110 to generate feedback 126. Feedback 126 is information that allows cloud service providers 110 to fine-tune the resource scheduling and optimize the service levels. Feedback 126 may be provided from assurance platform 120 to orchestrator 130.

Assurance platform 120 may use machine learning to generate feedback 126. In certain embodiments, assurance platform 120 uses machine learning to make predictions. For example, assurance platform 120 may predict, using machine learning and metrics 118 received from cloud service providers 110, that a particular service instance of cloud service provider 110 is going to suffer. As another example, assurance platform 120 may predict, using machine learning and metrics 118 received from cloud service providers 110, that a specific event (e.g., a maintenance event, a black Friday event, etc.) is going to occur. By making predictions, assurance platform 120 may save system 100 time since cloud service providers 110 can proactively prepare for the event rather than responding after the event occurs. By generating feedback 126, assurance platform 120 may assist in optimizing system 100 (e.g., optimizing total cost of ownership), which may reduce or eliminate the need for backup resources that are usually idle and are only used during times when high availability is needed. Assurance platform 120 includes collection engine 122 and database 124.

Collection engine 122 receives metrics 118 from cloud service providers 110. For example, collection engine 122 may receive metrics 118A from cloud service provider 110A, metrics 118B from cloud service provider 110B, and metrics 118C from cloud service provider 110C. Collection engine 122 may process metrics 118 to generate feedback 126. In certain embodiments, collection engine 122 applies machine learning to metrics 118 to generate feedback 126. Collection engine 122 communicates feedback 126 to database 124.

Database 124 of assurance platform 120 stores feedback 126 received from collection engine 122. Database 124 is an organized collection of data that maintains information generated by collection engine 122. Database 124 may be any one or a combination of volatile or non-volatile local or remote devices suitable for storing information. Database 124 may include RAM, ROM, magnetic storage devices, optical storage devices, or any other suitable information storage device or a combination of these devices. Database 124 may be located at any location suitable for database 124 to communicate with orchestrator 130. Database 124 may communicate feedback 126 to orchestrator 130.

Orchestrator 130 of system 100 facilitates coordination among agents 112 of cloud service providers 110. Orchestrator 130 may have one or more of the following responsibilities: orchestrating the life-cycle of services 114; managing resources; performing isolation and/or reservation of allocated resources for required SLA during a predetermined time window; performing triggered peer rescue based on thresholds for metrics 118 for high availability; performing affinity rules for data locality; performing affinity rules to coalesce/consolidate for performance and/or cost; performing anti-affinity rules that are policy based to avoid noisy neighbors; and/or performing priority and preemption for real-time critical path while under overall resource tightness.

Orchestrator 130 generates intent-based entries 134 using feedback 126 received from assurance platform 120. As such, intent-based entries 134 are based on metrics 118 (e.g., KPIs and cost metrics) received from cloud service providers 110. Intent-based entries 134 indicate service instances that need to be scheduled. Orchestrator 130 may update intent-based entries 134 based on feedback 126 received from assurance platform 120. Orchestrator 130 communicates intent-based entries 134 to cloud service providers 110 to facilitate the scheduling of services 114.

Database 132 of orchestrator 130 is an organized collection of data that maintains information (e.g., intent-based entries 134) for orchestrator 130. Database 132 may be any one or a combination of volatile or non-volatile local or remote devices suitable for storing information. Database 132 may include RAM, ROM, magnetic storage devices, optical storage devices, or any other suitable information storage device or a combination of these devices. Database 132 may be located at any location suitable for database 132 to communicate with cloud service providers 110.

Delivery network 140 of system 100 is any network that facilitates the transfer of information from cloud service providers 110 to client devices 150. In some embodiments, delivery network 140 uses domain name system (DNS) to facilitate the transfer of information from cloud service providers 110 to client devices 150. In certain embodiments, delivery network 140 uses service routing (SR) to provide services 114 to client devices 150. Cloud service providers 110 may use one or more application programming interfaces (APIs) and/or gateways to connect to delivery network 140.

Client devices 150 of system 100 are computer hardware and/or software that access services 114 made available by cloud service providers 110. In certain embodiments, client devices 150 use one or more applications to access services 114 made available by cloud service providers 110. Client devices 150 may store and/or operate one or more applications associated with one or more services 114. Client devices 150 may include phones (e.g., smartphones), desktop computers, laptop computers, tablets, personal digital assistants, wearables (e.g., smartwatches, fitness trackers, etc.), and the like. In the illustrated embodiment of FIG. 1, client devices 150 communicate with cloud service providers 100 via delivery network 140.

Region 160 of system 100 is an area defined by one or more characteristics (e.g., a fixed geographical boundary, a latency-defined perimeter, an ability to provide one or more services 114, etc.) Region 160 may be represented as a part of a country. For example, region 160 may be represented as Central United States (US), East US, North Central US, South Central US, Canada Central, Germany Northeast, West India, and the like. Region 160 may be associated with a region code (e.g., East US 2). The region code may distinguish regions within the same area (e.g., California). In the illustrated embodiment of FIG. 1, agents 112 of cloud service providers 110 are within the same region 160, which may allow services 114 to be optimized in terms of service cost, service quality, etc.

In operation, cloud service providers 110 communicate metrics 118 to collection engine 122 of assurance platform 120. Metrics 118 may include KPIs and/or cost metrics. Collection engine 122 of assurance platform 120 analyzes metrics 118 to generate feedback 126, which is stored in database 124. Database 124 of assurance platform 120 communicates feedback 126 to orchestrator 130. Orchestrator 130 updates intent-based entries 134 based on feedback 126 and communicates updated intent-based entries 134 to agents 112 of cloud service providers 110. Agents 112 of cloud service providers 110 share intent-based entries 134 and local information 117 (e.g., storage and compute requirements) among themselves to optimize services 114 provided to client devices 150. As such, system 100 of FIG. 1 utilizes self-optimizing agents 112 to reduce the overhead demands of orchestrator 130.

Although FIG. 1 illustrates a particular arrangement of cloud service providers 110, agents 112, services 114, databases 116, assurance platform 120, collection engine 122, database 124, orchestrator 130, database 132, delivery network 140, client devices 150, and region 160, this disclosure contemplates any suitable arrangement of cloud service providers 110, agents 112, services 114, databases 116, assurance platform 120, collection engine 122, database 124, orchestrator 130, database 132, delivery network 140, client devices 150, and region 160. For example, assurance platform 120 and orchestrator 130 may be combined into one network component.

Although FIG. 1 illustrates a particular number of cloud service providers 110, agents 112, services 114, databases 116, assurance platforms 120, collection engines 122, databases 124, orchestrators 130, databases 132, delivery networks 140, client devices 150, and regions 160, this disclosure contemplates any suitable number of cloud service providers 110, agents 112, services 114, databases 116, assurance platforms 120, collection engines 122, feedback databases 124, orchestrators 130, databases 132, delivery networks 140, client devices 150, and regions 160. For example, system 100 of FIG. 1 may include more or less than three cloud service providers 110.

FIG. 2 illustrates an example table 200 that may be used by system 100 of FIG. 1. In certain embodiments, orchestrator 130 of FIG. 1 uses table 200 to store intent-based entries 134 in database 132. In some embodiments, table 200 may part of a dashboard. A dashboard is a type of graphical user interface that provides at-a-glance views of information (e.g., intent-based entries 134) relevant to a particular service. In certain embodiments, the dashboard and/or accompanying table 200 may be displayed on a web page that is linked to database 132 that allows information (e.g., intent-based entries 134) to be constantly updated. The components of the dashboard may include one or more chart types, tables, metrics, gauges, etc. An operator of the dashboard may customize how the information is grouped, summarized, and/or displayed for each component (e.g., table 200) of the dashboard.

Table 200 includes a plurality of columns. Each column of table 200 includes a list of intent-based entries 134 related to a particular service. The columns of table 200 include a service column 210, a region/code column 220, a KPI/quality of service (QoS) class column 230, an agent commit column 240, a cloud service provider column 250, a state column 260, and any other suitable column (as represented by notation 270 in table 200).

Service column 210 of table 200 represents services (e.g., services 114 of FIG. 1) to be provided by a cloud service provider (e.g., cloud service providers 110 of FIG. 1). The services of table 200 include a virtual Customer Premises Equipment (vCPE) service, an SD-WAN service, and a cloud Digital Video Recorder (cDVR) service. Region/code column 220 of table 200 represents the region (e.g., region 160 of FIG. 1) where each associated service from service column 210 is to be provided. The region/code of table 200 include a Central US region (code 2), a West US region (code 2), and an East US region.

KPI/QoS class column 220 of table 200 represents the class of services offered, expressed in a package. The KPI/QoS classes of table 200 include a gold (2) class, a silver (3) class, and a platinum (1) class. The classes are related to the KPIs of the services. The platinum class may indicate the highest priority of service as compared to the gold and silver classes, the gold class may indicate a lower priority of service as compared to the platinum class and a higher priority of service as compared to the silver class, and the silver class may indicate a lower priority of service as compared to the gold and platinum classes. The numbers (i.e., 1, 2, and 3) may represent the priority order of the classes, with number 1 being the highest.

Agent commit column 240 of table 200 represents a commitment of a cloud service provider agent (e.g., agents 112 of FIG. 1) to provide the service. The agent commit column 240 of table 200 includes an agent's commitment (e.g., agent 112B of FIG. 1) for its associated cloud service provider B (e.g., cloud service provider 110B of FIG. 1) to provide the vCPE service (e.g., service 114B), as indicated by “YES” on the first row of table 200. The agent commit column 240 of table 200 includes an agent's commitment (e.g., agent 112A of FIG. 1) for its associated cloud service provider A (e.g., cloud service provider 110A of FIG. 1) to provide the SD-WAN service (e.g., service 114A), as indicated by “YES” on the second row of table 200. The agent commit column 240 of table 200 includes an undetermined commitment of an agent of a cloud service provider to provide the cDVR service, as indicated by “progressing” in the third row of table 200.

Cloud service provider column 240 of table 200 represents the cloud service provider (e.g., cloud service provider 110 of FIG. 1) that may provide each service of column 210 of table 200. The cloud service providers of table 200 include cloud service provider B (e.g., cloud service provider 110B of FIG. 1), cloud service provider A (e.g., cloud service provider 110A of FIG. 1), and cloud service provider C (e.g., cloud service provider 110C of FIG. 1). As indicated in table 200, cloud service provider B is intended to provide the vCPE service, cloud service provider A is intended to provide the SD-WAN service, cloud service provider B is intended to be an alternate to provide the SD-WAN service, and cloud service providers C, B, etc. are intended to provide the cDVR service (as prioritized by the order indicated).

State column 260 of table 200 represents a state of each service of column 210. The states of table 200 include a service up state, a scaling up state, and a pending state. The service up state indicates that the vCPE service is currently running. The scaling up state indicates that the SD-WAN service is scaling up (e.g., increase the capacity of its existing infrastructure by adding additional resources). The pending state indicates that the cDVR service is pending (e.g., preparing to enter the running state). A service may enter the pending state when a service instance launches for the first time or when the service instance is restarted after being in the stopped state. Column 270 of table 200 represents any other suitable column that may include a category of itent-based entries 134 related to the services of service column 210.

In certain embodiments, orchestrator 130 of FIG. 1 stores intent-based entries 134 of table 200 in database 124 and dynamically updates intent-based entries 134 in accordance with feedback 126 received from assurance platform 120. Orchestrator 130 communicates updated intent-based entries 134 of table 200 to one or more cloud service providers 110, which use intent-based entries 134 to optimize services provided to client devices 150. By not including local information 170 (e.g., storage and compute resources of cloud services providers 110) in table 200, table 200 is significantly simplified, which reduces the overhead demands on orchestrator 130.

Although FIG. 2 illustrates a particular arrangement of table 200, including a particular arrangement of service column 210, region/code column 220, KPI/QoS class column 230, agent commit column 240, cloud service provider column 250, and state column 260, this disclosure contemplates any suitable arrangement of table 200. For example, service column 210 and cloud service provider column 250 may be reversed. Although FIG. 2 illustrates a particular number of tables 200 and associated columns and rows, this disclosure contemplates any suitable number of tables 200 and columns and rows. For example, table 200 may include more or less than six columns. Although the information (e.g., the intent-based entries 134) of FIG. 2 is illustrated in a particular format, this disclosure contemplates any suitable format. For example, the information (e.g., intent-based entries 134) of FIG. 2 may be included in a graph, a chart, a table, a combination thereof, or any other suitable format.

FIG. 3 illustrates an example method 300 for orchestrating cloud resources. Method 300 begins at step 305. At step 310, one or more cloud service providers (e.g., cloud service providers 110 of FIG. 1) communicate metrics (e.g., metrics 118 of FIG. 1) to an assurance platform (e.g., assurance platform 120 of FIG. 1). The metrics may include KPIs and cost metrics. The cloud service providers may be located in the same region (e.g., region 160 of FIG. 1) to optimize services in terms of service cost, service quality, etc. Method 300 then moves from step 310 to step 315, where the assurance platform analyzes the metrics to generate feedback (e.g., feedback 126 of FIG. 1). The feedback is any information that assists with scheduling service instances. In certain embodiments, the feedback may include predictions generated by the assurance platform using machine learning algorithms. Method 300 then moves from step 315 to step 320.

At step 320, the assurance platform communicates the feedback to an orchestrator (e.g., orchestrator 130 of FIG. 1). The orchestrator is responsible for generating and updating intent-based entries (e.g., intent-based entries 134 of FIG. 1) that assist with scheduling service instances. Method 300 then moves from step 320 to step 325, where the orchestrator analyzes the feedback in light of the intent-based entries. The intent-based entries may be stored in a database (e.g., database 124 of FIG. 1). In certain embodiments, the intent-based entries may be arranged in a table (e.g., table 200 of FIG. 2) and displayed as part of a dashboard. The dashboard may be displayed on a web page that is linked to the database, which allows the intent-based entries to be automatically updated. Method 300 then moves from step 325 to step 330.

At step 330, the orchestrator determines whether the intent-based entries have changed based on the feedback received from the assurance platform. For example, the intent-based entries may include an SD-WAN service instance associated with a particular region, KPI/QoS class, agent commitment, cloud service provider, and/or state, and the orchestrator may determine whether the intent-based entries for the particular region, KPI/QoS class, agent commitment, cloud service provider, and/or state have changed. If the orchestrator determines that the intent-based entries have not changed based on the feedback received from the assurance platform, method 300 advances from step 325 to step 350, where method 300 ends.

If, at step 325, the orchestrator determines that one or more of the intent-based entries have changed based on the feedback received from the assurance platform, method 300 moves from step 330 to step 335, where the orchestrator updates the intent-based entries using the feedback received from the assurance platform. For example, the orchestrator may determine that the intent-based entry for the cloud service provider for the SD-WAN service instance changed from cloud service provider A to cloud service provider B and update the intent-based entry accordingly. As another example, the orchestrator may determine that the intent-based entry for the KPI/QoS class for of the vCPE service instance changed from gold to silver and update the intent-based entry accordingly. In certain embodiments, the orchestrator updates the intent-based entries dynamically. Method 300 then moves from step 335 to step 340.

At step 340, the orchestrator communicates the updated intent-based entries to agents (e.g., agents 112) of the cloud service providers. Method 300 then moves from step 340 to step 345, where the agents collaborate to optimize services provided to client devices (e.g., client devices 150 of FIG. 1) using the intent-based entries received from the orchestrator and local information (e.g., local information 117 of FIG. 1) that has not been made available to the orchestrator. For example, agent 112A of cloud service provider 110A of FIG. 1 may determine, based on the intent-based entries, that cloud service provider 110A is to provide service 114A. Agent 112C of cloud service provider 110C, which has a better service quality that cloud service provider 110A, may send a recommendation (e.g., recommendation 113 of FIG. 1) to agent 110A offering to provide information about resource configurations that may be used to obtain better service quality for service 114A, and agent 110A may receive/accept this recommendation from cloud service provider 110C to improve its quality of service. Method 300 then moves from step 345 to step 350, where method 200 ends. As such, method 300 of FIG. 3 may be used to reduce the overhead demands of the orchestrator by utilizing self-optimizing agents.

Although this disclosure describes and illustrates an example method for orchestrating cloud resources including the particular steps of the method of FIG. 3, this disclosure contemplates any suitable method for orchestrating cloud resources, including any suitable steps, which may include all, some, or none of the steps of the method of FIG. 3, where appropriate. Although this disclosure describes and illustrates particular steps of method 300 of FIG. 3 as occurring in a particular order, this disclosure contemplates any suitable steps of method 300 of FIG. 3 occurring in any suitable order. Although this disclosure describes and illustrates particular components, devices, or systems carrying out particular steps of method 300 of FIG. 3, this disclosure contemplates any suitable combination of any suitable components, devices, or systems carrying out any suitable steps of method 300 of FIG. 3.

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes RAM. This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes ROM. Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a LAN, a WAN, a MAN, or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a LTE network, or a 5G network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

What is claimed is:

1. A controller, comprising:
one or more processors; and
one or more computer-readable non-transitory storage media coupled to the one or more processors and comprising instructions that, when executed by the one or more processors, cause the controller to perform operations comprising:
generating intent-based entries, wherein the intent-based entries comprise information associated with scheduling of service instances;
receiving feedback from an assurance platform, wherein:
the feedback is generated by the assurance platform using metrics received from cloud service providers; and
each of the cloud service providers is associated with an agent;
determining updates for the intent-based entries based on the feedback; and
communicating the updates for the intent-based entries to agents of the cloud service providers.

2. The controller of claim 1, wherein the agents of the cloud service providers schedule the service instances using the updates for the intent-based entries and local information of the cloud service providers.

3. The controller of claim 2, wherein the local information of the cloud service providers is associated with storage and compute resources of the cloud service providers.

4. The controller of claim 1, wherein the metrics comprise at least one of:
key performance indicators (KPIs) associated with the cloud service providers; or
cost metrics associated with the cloud service providers.

5. The controller of claim 1, wherein the intent-based entries are associated with at least one of:
a service;
a region;
a Quality of Service (QoS) class; or
a state.

6. The controller of claim 1, wherein the cloud service providers are located within a single region.

7. The controller of claim 1, wherein the feedback comprises one or more predictions generated by the assurance platform using machine learning algorithms.

8. A method, comprising:
generating, by a controller, intent-based entries, wherein the intent-based entries comprise information associated with scheduling of service instances;
receiving, by the controller, feedback from an assurance platform, wherein:
the feedback is generated by the assurance platform using metrics received from cloud service providers; and
each of the cloud service providers is associated with an agent;
determining, by the controller, updates for the intent-based entries based on the feedback; and
communicating, by the controller, the updates for the intent-based entries to agents of the cloud service providers.

9. The method of claim 8, wherein the agents of the cloud service providers schedule the service instances using the updates for the intent-based entries and local information of the cloud service providers.

10. The method of claim 9, wherein the local information of the cloud service providers is associated with storage and compute resources of the cloud service providers.

11. The method of claim 8, wherein the metrics comprise at least one of:
key performance indicators (KPIs) associated with the cloud service providers; or
cost metrics associated with the cloud service providers.

12. The method of claim 8, wherein the intent-based entries are associated with at least one of:
a service;
a region;
a Quality of Service (QoS) class; or
a state.

13. The method of claim 8, wherein the cloud service providers are located within a single region.

14. The method of claim 8, wherein the feedback comprises one or more predictions generated by the assurance platform using machine learning algorithms.

15. One or more computer-readable non-transitory storage media embodying instructions that, when executed by a processor, cause the processor to perform operations comprising:
generating intent-based entries, wherein the intent-based entries comprise information associated with scheduling of service instances;
receiving feedback from an assurance platform, wherein:
the feedback is generated by the assurance platform using metrics received from cloud service providers; and
each of the cloud service providers is associated with an agent;
determining updates for the intent-based entries based on the feedback; and
communicating the updates for the intent-based entries to agents of the cloud service providers.

16. The one or more computer-readable non-transitory storage media of claim 15, wherein the agents of the cloud service providers schedule the service instances using the updates for the intent-based entries and local information of the cloud service providers.

17. The one or more computer-readable non-transitory storage media of claim 16, wherein the local information of the cloud service providers is associated with storage and compute resources of the cloud service providers.

18. The one or more computer-readable non-transitory storage media of claim 15, wherein the metrics comprise at least one of:
key performance indicators (KPIs) associated with the cloud service providers; or
cost metrics associated with the cloud service providers.

19. The one or more computer-readable non-transitory storage media of claim 15, wherein the intent-based entries are associated with at least one of:
a service;
a region;
a Quality of Service (QoS) class; or
a state.

20. The one or more computer-readable non-transitory storage media of claim 15, wherein the cloud service providers are located within a single region.
